(19) United States
(12) Patent Application Publication
(10) Pub. No.: US 2006/0043024 A1
(43) Pub. Date: Mar. 2, 2006

(54) Multi-stage Carbon Block Filters

(76) Inventors: Eric Taylor, Oakland, CA (US); A Alex Tipton, Oakland, CA (US)

Correspondence Address: THE CLOROX COMPANY, P.O. BOX 24305, OAKLAND, CA, 94623-1305, US

(21) Appl. No.: 10/930,215

(22) Filed: Aug. 31, 2004

(51) Int. Cl. B01D 29/00

(52) U.S. Cl. 210/660; 210/496

(57) ABSTRACT

Abstract of the Disclosure

A porous composite block for fluid treatment is described. The block has at least two stages or portions in fluid communication with one another; a first portion and a second portion located upstream of the first portion. Both the first portion and the second portion can contain one or more active particle types. The first portion contains a binder and first active particles of a predominant first active particle type. The first active particles have a first particle size. The second portion contains a binder and second active particles of a second active particle type. The second particle size is smaller than the first particle size. In some arrangements, the second particle size is less than about 50 μm. In some arrangements, the second particle size is less than about 1 μm.

### Detailed Description of the Invention

### Field of the Invention

This invention relates generally to porous composite blocks, and, more specifically, to porous composite block structures that minimize loss of small particulate media as fluids flow through the blocks.

### Description of the Related Art

Typically, a composite block filter is a hollow core cylindrical block of bonded, activated carbon grains. Water flows through the perimeter of the carbon filter, into the center core and on to the user. It is the interaction of water with the carbon surface that removes impurities.

However, carbon alone cannot remove all the impurities of interest. Often other active media (actives) that can remove additional impurities are mixed with activated carbon and binder particles to form a porous composite block filter. It is desirable to use actives in fine particulate form to optimize the surface area per unit volume. When a mixture of activated carbon grains, binder particles, and fine particulate actives forms a porous composite block filter, the carbon grains and the binder particles form a basic network structure. Some smaller active particles are also attached to binder particles, but many small particles are merely distributed within the pores of the basic network structure. Many small active particles are lost subsequently when fluid enters the block and carries the particles along with it as it flows through channels within the network. Typically, manufacturers include many more small active particles in the porous composite block mixtures than are required for fluid treatment to allow for particle loss during block use. Often small active particles of interest are among the most expensive components of porous composite blocks. It drives up the cost of producing porous composite blocks for fluid treatment to lose these expensive media during use.

Accordingly, there is a need for improved processes and materials for making porous composite block filters that can minimize loss of small active particles.

### Summary of the Invention

A porous composite block for fluid treatment is provided. The block has at least two portions or stages in fluid communication with one another; a first portion and a second portion located upstream of the first portion. Both the first portion and the second portion can contain one or more types of active particles. The first portion contains a binder and first active particles of a predominant first active particle type. The first active particles have a first particle size. The second portion contains a binder and second active particles of a second active particle type. The second particle size is smaller than the first particle size. In some arrangements, the second particle size is less than about 50 μm. In some arrangements, the second particle size is less than about 1 μm.

A system for fluid treatment a method of fluid treatment, and some methods of making a porous composite block are also provided.

### Brief Description of the Drawings

The foregoing aspects and others will be readily appreciated by the skilled artisan from the following description of illustrative embodiments when read in conjunction with the accompanying drawings.

Figure 1 is a schematic drawing of a porous composite block, according to an embodiment of the invention.

Figure 2 is a schematic drawing that illustrates how active particles can move within a porous composite block in response to fluid flow.

Figure 3A shows a perspective view of a concentric annular porous composite block, according to an embodiment of the invention.

Figure 3B is a cross-section view of the block shown in Figure 3A.

Figure 4 is a schematic drawing of a porous composite block, according to another embodiment of the invention.

Figure 5 is a schematic drawing that shows a porous composite block that contains several block portions, according to an embodiment of the invention.

Figures 6A is a plot of number of particles as a function of position in a porous composite block, illustrating an exemplary composition gradient.

Figure 6B is a schematic drawing that shows a porous composite block that has the composition gradient shown in Figure 6B, according to an embodiment of the invention.

Figure 7 shows turbidity data for Block A and Block B as discussed in the example.

Figures 8A, 8B, and 8C are schematic drawings that illustrate a method of making a porous composite block for fluid treatment, according to an embodiment of the invention.

Figures 9A, 9B, 9C, and 9D are schematic drawings that illustrate a method of making a porous composite block for fluid treatment, according to another embodiment of the invention.

Figures 10A, 10B, 10C, and 10D are schematic drawings that illustrate a method of making a porous composite block for fluid treatment, according to yet another embodiment of the invention.

### Detailed Description

The embodiments of the invention are illustrated in the context of porous composite carbon blocks for use in water filtration systems. The skilled artisan will readily appreciate, however, that the materials and methods disclosed herein will have application in a number of other contexts where porous composite blocks that have large amounts of surface area available for interaction with a fluid are desirable, such as, for example, in air purification, or catalytic treatment.

The term “porous composite block” is used herein to mean a block that is porous and permeable to a fluid. The fluid can move through the block under the influence of an outside force, such as pressure in a water line. In some arrangements, fluids can move through the block under the force of gravity alone. Porous composite blocks are usually made of granular media that are held together by binder material(s). Porous composite blocks can be used for fluid (i.e., liquid and gas) filtration and treatment. Porous composite blocks can be used for water filtration and treatment in both pressurized and gravity-flow water treatment systems.

The terms “active particles” and “actives” are used to mean particulate filter media that can interact with fluids to remove one or more contaminants.

The term “binder” is used to mean a material which, after a processing treatment, can stick to active particles in a porous composite block and thereby contribute to the block’s physical integrity. In some cases, the binder can also act as an active as defined above. Binders suitable for use in porous composite blocks have been discussed by Taylor and Rinker in U.S. Patent Application Number 10/756478, filed January 12, 2004, which is included by reference herein.

The term “particle size” refers to the mean particle size for a batch of particles of a particular particle type. As practitioners skilled in the art of porous composite block manufacture know, a batch of particles has a range of particle sizes that can be plotted on a size distribution curve. It can be difficult to get details about size distribution curves from particle suppliers who generally characterize a batch of particles for their customers by a mean particle size alone.

The term “type” of active particle is used to mean a batch or group of particles that have the same composition and a range of sizes that can be described by a mean particle size. “Predominant active particle type” in a porous composite block portion is used to mean the active particle type that occupies the most active particle volume in the portion.

Conventionally, the basic components of porous composite blocks as used for fluid treatment include active particles and binders. Multiple actives can be included in the blocks as desired for specific fluid treatment applications. Examples of actives include activated carbon, activated alumina, activated bauxite, fuller’s earth, diatomaceous earth, sand, glass, clay, silica gel, calcium sulfate, magnesia, ceramic particles, zeolite particles, inert particles, silica, mixed oxides, cation salts, anion salts, surface charge-modified particles, cationic materials (including polymers such as polyaminoamides, polyethyleneimine, polyvinylamine, polydiallyldimethylammonium chloride, polydimethylamine-epichlorohydrin, polyhexamethylenebiguanide, poly-[2-(2-ethoxy)-ethoxyethyl-guani-dinium chloride which may be bound to fibers (including polyethylene, polypropylene, ethylene maleic anhydride copolymers, carbon, glass, etc.), carbon fibers, metal oxides, metal hydroxides or mixtures thereof. Additional active components can be chosen for their fluid purification properties. Additional examples of actives that can be used in water filters are disclosed in U.S. Patent Nos. 6,274,041 and 5,679,248, both of which are incorporated by reference herein.

Figure 1 is a schematic drawing of a porous composite block 100 that contains a first stage or portion 110 and a second stage or portion 120, according to an embodiment of the invention.

The second portion 120 of the porous composite block 100 contains second active particles and binder. There can be one or more different second active particle types in the second portion 120.

In one embodiment, for a gravity-flow fluid treatment system, the first portion 110 of the porous composite block 100 is located downstream of the second portion 120. The first portion contains first active particles and binder. There can be one or more different first active particle types in the first portion 110. In some arrangements, activated carbon granules are the predominant first active particles in the first portion 110.

Fluids can flow through the porous composite block 100 with no outside force except for the force of gravity. Fluids are treated by the porous composite block 100 and can be transmitted through the block at a rate of at least 0.19 liters/min.

In another embodiment for both gravity-flow fluid treatment systems and pressurized water treatment systems, the first portion 110 of the porous composite block 100 is located downstream of the second portion 120. The first portion 110 contains first active particles and binder. There can be one or more different first active particle types in the first portion 110. In some arrangements, activated carbon granules are the predominant first active particles in the first portion 110. The first active particles of the predominant first active particle type have a particle size that is larger than the size of the second active particles of the smallest type. At least one second active particle type has a particle size less than about 50 μm. In some arrangements, at least one type of second active particle has a particle size less than about 25 μm. In some arrangements, at least one type of second active particle has a particle size less than about 10 μm. In other arrangements, at least one type of second active particle has a particle size less than about 1 μm. In yet other arrangements, at least one type of second active particle has a particle size less than about 100 nm.

In some arrangements, the binder in the first portion 110 and the binder in the second portion 120 are the same. In other arrangements, the binder in the first portion 110 and the binder in the second portion 120 are different. The binder in any portion can include one or more materials.

When the porous composite block 100 is used for fluid treatment, a fluid (not shown) enters the second portion 120 through upstream surface 130. In some arrangements, the fluid enters and flows through the block 100 by the force of gravity alone. In other arrangements, the fluid is under pressure, such as from a household water system, thus entering and flowing through the block 100 with a force that is greater than the force of gravity alone. The fluid passes through the second portion 120 and then out of the second portion 120 through downstream surface 140. The fluid enters the first portion 110 of the porous composite block 100 through upstream surface 150 of the first portion 110. The fluid passes through the first portion 110 and then out of the first portion 110 through downstream surface 160. In Figure 1 the downstream surface 140 of the second portion 120 and the upstream surface 150 of the first portion 110 are shown in continuous contact. In other arrangements, there can be spaces or gaps between the downstream surface 140 and the upstream surface 150. In yet other arrangements, there can be no contact at all, or there can be additional material between the downstream surface 140 and the upstream surface 150, although there is still fluid communication between the second portion 120 and the first portion 110. Treated fluid exits the first portion 110 through downstream surface 160.

Fluid cannot enter the second portion 120 through any surface other than the upstream surface 130. Fluid cannot exit the first portion 110 through any surface other than the downstream surface 160. Surfaces 102 are sealed, and fluid cannot pass through them.

Some second active particles of the second particle type can become dislodged from the second portion 120 and be carried along with the fluid as it continues flowing out of the second portion 120 and into the first portion 110 of the porous composite block 100. A substantial portion of the second active particles of the second particle type in the fluid can be captured in the first portion 110 as the fluid flows through. It may be that the nominal pore size of the first portion 110 is no larger than the size of the second active particles. As fluid flows through the porous composite block 100 and second active particles are captured in the first portion 110, the nominal pore size of the first portion 110 can decrease, thus enhancing the ability of the first portion 110 to capture even smaller particles.

Figure 1 is a schematic drawing that shows one possible arrangement of the first portion 110 and the second portion 120 of the porous composite block 100. Other geometries that cause fluids to pass through the first portion 110 after exiting the second portion 120 are possible within the embodiments of the invention.

Figure 2 illustrates how active particles can move within a porous composite block as fluid flows therethrough. Figure 2 is a two-dimensional view of active particles within a small enlarged section 200 of the porous composite block 100 shown in Figure 1. The view in Figure 2 is not meant to be a true cross section of an actual block, as it is unlikely that active particles 215, 225 have a co-planar arrangement. In an actual block some of the active particles 215, 225 can be above the plane of the paper, some can be below the plane of the paper, and some can be in the plane of the paper. Furthermore, pores 217 between the active particles 215, 225 in an actual block are not two-dimensional as represented in Figure 2, but are three-dimensional. Because of the three-dimensional character of the arrangement of the active particles 215, 225, actual paths between the active particles can be larger than they appear in Figure 2.

A first portion 210 in the section 200 contains the first active particles 215 of a first particle type. The pores 217 have a nominal pore size of about 1 μm. The first active particles have a particle size of about 100 μm. In the example of Figure 2, the first particle type particles 215 are activated carbon. A second portion 220 contains the second active particles 225 of a second particle type. In the example of Figure 2, the second active particles 225 are lead scavengers with a particle size of about 5 μm. For ease of illustration, the first portion 210 contains only one first particle type, the second portion 220 contains only one second particle type, and no binders are shown in Figure 2. As discussed above, each portion can have more than one type of active particle and each portion can contain the same or different binder(s), according to embodiments of the invention.

A fluid (not shown) enters the section 200 through entry 230, which is the most upstream part of the second portion 220 shown in Figure 2. As the fluid flows through the second portion 220, some second active particles 225 become liberated from the second porous composite block portion 220 and liberated second active particles 225′ are carried along with the fluid as it continues flowing through the section 200. When the fluid containing the liberated second active particles 225′ enters the first porous composite block portion 210, the liberated second active particles 225′ are captured in the pores 217 in the first portion 210. In the example of Figure 2, the second actives 225, 225′ have a particle size of about 5 μm and the first portion 210 has a nominal pore size of about 1 μm. A significant percentage of the liberated second active particles 225′ are captured in the first portion 210 of the section 200 of the porous composite block as the fluid flows from the entry 230 to exit 260, which is the most downstream part of the first portion 210 shown in Figure 2. Only a negligible amount of liberated second active particle 225′ remains in the fluid as the fluid exits the first portion 210 of the porous composite block.

When active particles liberated by fluid flowing through an upstream portion of a porous composite block have a particle size that can be captured in a downstream portion of the porous composite block, only a negligible amount of the liberated active particles remains in the fluid as the fluid leaves the porous composite block.

There is some correlation between particle size and pore size in porous composite blocks. Generally, the pores are much smaller than the particles, and the larger the particles, the larger the pores.

In general, when a downstream portion of a porous composite block contains a significant amount of particles larger than the liberated particles from an upstream portion, which are carried by fluid flowing through the block, the liberated particles can be captured in the downstream portion. Only a negligible amount of liberated particles remains in the fluid as the fluid exits the porous composite block.

Figure 3A shows a concentric annular porous composite block 300, according to an embodiment of the invention. The block 300 contains two stages or portions 310, 320. The first portion 310 contains binder and first active particles of a first particle type that have a first particle size. The second portion 320 contains binder and second active particles of a second particle type that have a second particle size. The first particle size is larger than the second particle size. The first portion 310 can capture liberated second active particles in a fluid stream as the fluid stream passes through.

End surface 302 of the block 300 is sealed to prevent fluid from entering or leaving the block 300 through the end surface 302 during use. As shown by the bold arrows 370, fluid enters the block 300 through outermost or upstream cylindrical surface 330. The fluid flows through the second portion 320, then through the first portion 310, and then, as treated fluid, enters cavity 380 near the center of the block. End surface 304 of the block 300 is sealed except for opening 306 where the cavity 380 meets the end surface 304. The opening 306 allows treated fluid in cavity 380 to exit the block 300.

Fluid flow direction in Figure 3A is shown from the outermost surface 330 to the inner cavity 380. In other arrangements, the porous composite block portion positions can be reversed and fluid can flow from the inner cavity to the outermost surface. Many fluid flow arrangements are possible within the scope of the invention as long as the second active particles in the upstream (or second) portion have a particle size that can be captured by the downstream (or first) portion, as will be discussed in more detail in Figure 5 below.

Figure 3B is a cross-section view of the block 300 as taken along the line A–A in Figure 3A. Fluid flows into the block through upstream surface 330 of the second portion 320 of the block. The fluid flow direction is indicated by bold arrows 370. As fluid flows through the second portion 320, some second active particles in the second portion 320 are liberated by the fluid and carried along as the fluid continues through the block. The fluid flows through downstream surface 340 of the second portion 320 and into the first portion 310 of the porous composite block. As the fluid moves through first section 310, a very large percentage of the second active particles are trapped in the first section 310. Thus, although some second active particles may move from the second portion 320 to the first portion 310, they are not lost to the block. Second active particles trapped in the first portion 310 can still provide treatment to fluids in the block. Only a negligible amount of second active particles are flushed out of the block. Nearly all second active particles stay in either the second portion 320 or the first portion 310 of the block during the useful lifetime of the block.

Thus, it is no longer desirable to include additional small second active particles during block manufacture to mitigate particle loss during fluid treatment. Block manufacturers can optimize block compositions by using just the amount of small actives necessary for contaminant removal, thus avoiding the cost of adding extra active particles to allow for active particle loss during use. Furthermore, upon exiting the block, treated fluids contain negligibly few second active particles, resulting in low turbidity measurements in the treated fluids. In addition to the cost benefit, there is also a consumer benefit, especially in water filtration systems. Generally, consumers do not like to see turbid water flowing from their water filtration systems, even if the turbidity does decrease as the filter is used. If small particles are captured within the block, they cannot contribute to turbidity, and the filtered water is clearer.

Figure 4 is a schematic drawing of a porous composite block 400 that contains a first portion 410 and any number, n, of upstream portions 490, according to an embodiment of the invention. Fluid enters the porous composite block 400 through entry surface 430, which is the most upstream surface of the upstream portions 490. Treated fluid leaves the porous composite block 400 through exit surface 460, which is the downstream surface of the first portion 410. Fluid cannot enter or leave the block 400 through surfaces 402.

The first portion 410 of the porous composite block 400 contains active particles and binder. There can be one or more different types of first active particle in the first portion 410. In some arrangements, activated carbon granules are the predominant active particle type of the first portion 410.

Upstream of the first portion 410 there can be any number, n, additional portions 490. Each of the n portions 490 contains binder and n^{th} active particles that have an n^{th} particle size. According to an embodiment of the invention, for each n^{th} portion containing n^{th} active particles, wherein among the n^{th} active particles there is a type of active particle of interest having an n^{th} particle size, there is another portion downstream of the n^{th} portion within the same porous composite block that has active particles that have a particle size larger than the n^{th} particle size.

Figure 4 is a schematic drawing that shows one possible arrangement of the first portion 410 and n additional portions 490 of the porous composite block 400. As discussed above, other geometries are possible within the embodiments of the invention. For a case where n = 1, Figure 4 and Figure 1 are essentially the same.

Figure 5 is a schematic drawing that shows a porous composite block 500 for a case where n = 3. A first portion 510 of the porous composite block 500 contains active particles and binder. There can be one or more different types of first active particle in the first portion 510. In some arrangements, activated carbon granules are the predominant active particle type of the first portion 510.

Upstream of the first portion 510 there are three additional portions 591, 592, 593. Portion 591 contains (n = 1)^{th} active particles and binder. The (n = 1)^{th} active particles have an (n = 1)^{th} particle size. Portion 592 contains (n = 2)^{th} active particles and binder. The (n = 2)^{th} active particles have an (n = 2)^{th} particle size. Portion 593 contains (n = 3)^{th} active particles and binder. The (n = 3)^{th} active particles have an (n = 3)^{th} particle size. For each portion 591, 592, 593, there is at least one portion located downstream that has a particle size larger than the particle size of that portion, as summarized in Table I. TABLE I

| | | c |
|---|---|---|
| | | At least one downstream portion |
| | | contains a predominant particle type |
| a | b | that has a particle size larger |
| Portion | Particle size | than the one in column b |
| 591 | (n = 1)^{th} | 510 |
| 592 | (n = 2)^{th} | 591510 |
| 593 | (n = 3)^{th} | 592591510 |

Fluid enters the porous composite block 500 through entry surface 530, which is the upstream surface of most upstream portion 593. Treated fluid leaves the porous composite block 500 through exit surface 560, which is the downstream surface of the first portion 510. Fluid cannot enter or leave the block 500 through surfaces 502.

The discussion in Figures 1-5 could be interpreted to indicate that each block portion has its own discrete composition. Discrete compositions where the changes in composition as a function of position in the block can be shown as step functions at the portion boundaries are within the scope of the invention. But other composition arrangements are possible.

Figures 6A and 6B show an embodiment of the invention wherein the portions of the porous composite block do not have compositions that correspond to a step function, wherein each portion has a specific, well-defined composition, but rather there are gradients in composition throughout the block. Figure 6A is an exemplary plot of number of particles as a function of position in a porous composite block 600 for first particles 615 of a first particle type and second particles 625 of a second particle type. Absolute values along the y-axis can be different for the first particle 615 curve and the second particle 625 curve. The predominant particle type in downstream region 610′ of the block is first particle 615. There is an overwhelming amount of second particles 625 in upstream region 620′ of the block as compared to downstream region 610′. The intervening region 612′ contains a smaller amount of first particles 615 than are in region 610′ and a larger amount of first particles 615 than are in region 620′. The intervening region 612′ contains a smaller amount of second particles 625 than are in region 620′ and a larger amount of second particles 625 than are in region 610′.

Of course, other composition gradients are possible. The gradient shown in figure 6A is meant to be an example of a possible composition gradient that is different from a step function. Examples of other composition gradients include gradients that are linear across the block or gradients that have long, flat tails extending toward each block surface.

Figure 6B is a schematic drawing showing a first portion 610, a second portion 620, and an intervening portion 612 of the porous composite block 600 that has the composition gradient shown in Figure 6A. The first portion 610 can capture the second particles 625 that are liberated from the second portion 620 as fluid flows through the block 600 from the second portion 620, through the intervening portion 612, and into the first portion 610. As discussed above in reference to Figure 1, there can be additional material, such as, for example, the intervening portion 612, between the first and second portions of a porous composite block. Second particles 625 liberated from the intervening portion 612 by fluid flow can also be captured in the first portion 610. In addition, some second particles 625 from the second portion 620 may also be captured in intervening portion 612.

### Example

Two porous composite blocks for water filtration were prepared. Block A is a conventional block, that is, a block with a substantially homogeneous composition and no distinguishable separate portions. Block B has two separate stages or portions as described in the embodiments of the invention. The compositions of Blocks A and B are shown in Table II. Table II wt% = weight percent of constituent particles

| | | | | |
|---|---|---|---|---|
| Constituent | | Block B | Block B | Block B |
| Particles/ | | Overall | Downstream | Upstream |
| Particle Size | Block A | Composition | Stage | Stage |
| Lead scavenger/ | 10.0 wt % | 10.0 wt % | 0.0 wt % | 30.0 wt % |
| 4 μm | | | | |
| Activated | 70.0 wt % | 68.5 wt % | 80.0 wt % | 45.0 wt % |
| carbon/95 μm | | | | |

Water was flowed through Block A and Block B and turbidity measurements were made on the effluents. The turbidity measurements were made on effluent samples of about 25 ml that were taken after various volumes of water had flowed through each block. Plots of the results are shown in Figure 7. Curve 710 shows the data for Block A and curve 720 shows the plot for Block B. Clearly, Block A lost a much larger amount of particles than did Block B during the first 10 liters of water flow. It is evident that the two-stage filter block (Block B) lost only a negligible amount of media from the block. The result can be attributed to capture of lead scavenger particles (4 μm) in the downstream stage of the block.

In another aspect of the invention a method of treating a fluid is provided. The method includes providing a first portion of a porous composite block. The first portion contains a binder and first active particles of a first particle type that have a first particle size. Next, a second portion of a porous composite block is provided. The second portion contains a binder and second active particles of a second particle type. The second active particles have a second particle size that is smaller than the first particle size. The second portion has an upstream surface and a downstream surface and the downstream surface is adjacent the first portion. In the next step a fluid is introduced into the upstream surface of the second portion of the porous composite block. Finally the fluid flows through the second portion into the first portion and through the first portion of the porous composite block, thus treating the fluid.

In another aspect of the invention, Figures 8A, 8B, and 8C illustrate a method of making a porous composite block for fluid treatment. In Figure 8A a first mixture 815 of first active particles with a binding agent and a second mixture 825 of second active particles with a binding agent are provided. The first mixture 815 and the second mixture 825 can each include one or more active particle types. The smallest second active particles have a particle size that is smaller than the particle size of the first active particles of the predominant first active particle type. The binding agent(s) in the first mixture and 815 and the second mixture 825 may or may not be the same. In Figure 8B the first mixture 815 is arranged into a first shape 817. The second mixture 825 is arranged into a second shape 825 adjacent the first shape 817. In Figure 8C the shapes 817, 827 are coalesced into a porous composite block 800 having a first portion 810 produced from the first shape 817 and a second portion 820 produced from the second shape 827.

Although the exemplary embodiment of Figures 8A, 8B, and 8C show a very simple rectangular block arrangement, any geometry that causes fluids to pass through the first portion 810 after exiting the second portion 820 is possible within the embodiments of the invention, as has been discussed above. There can also be a gap or intervening layer(s) between first portion 810 and second portion 820 in the block 800.

In another aspect of the invention, Figures 9A, 9B, 9C, and 9D illustrate another method of making a porous composite block for fluid treatment. In Figure 9A a first mixture 915 of first active particles with a binding agent and a second mixture 925 of second active particles with a binding agent are provided. The first mixture 915 and the second mixture 925 can each include one or more active particle types. The smallest second active particles have a particle size that is smaller than the particle size of the first active particles of the predominant first active particle type.

In Figure 9B the first mixture 915 is formed into a first shape 917. In Figure 9C the first shape 917 is coalesced into a first porous composite block portion 910 and then the second mixture 925 is formed into a second shape 927 adjacent the first portion 910. In Figure 9D the second shape 927 is coalesced into a second porous composite block portion 920 adjacent the first portion 910. Thus a porous composite block 900 contains a first portion 910 produced from the first shape 917 and a second portion 920 produced from the second shape 927.

In a variation (not shown) on the method described in Figures 9A, 9B, 9C, and 9D, after providing the first mixture 915 and the second mixture 925, the second mixture 925 is formed into a second shape 927. The second shape 927 is coalesced into a second porous composite block portion 920 and then the first mixture 915 is formed into a first shape 917 adjacent the second portion 920. Then the first shape 917 is coalesced into a first porous composite block portion 910 adjacent the second portion 920. Thus the porous composite block 900 contains the first portion 910 produced from the first shape 917 and the second portion 920 produced from the second shape 927.

Although the exemplary embodiment of Figures 9A, 9B, 9C, and 9D shows a very simple rectangular block arrangement, any geometry that causes fluids to pass through the first portion 910 after exiting the second portion 920 is possible within the embodiments of the invention, as has been discussed above. There can also be a gap or intervening layer(s) between first portion 910 and second portion 920 in the block 900.

In another aspect of the invention, Figures 10A, 10B, 10C, and 10D illustrate a method of making a porous composite block for fluid treatment. In Figure 10A a first mixture 1015 of first active particles with a binding agent and a second mixture 1025 of second active particles with a binding agent are provided. The first mixture 1015 and the second mixture 1025 can each include one or more active particle types. The smallest second active particles have a particle size that is smaller than the particle size of the first active particles of the predominant first active particle type.

In Figure 10B the first mixture 1015 is formed into a first shape 1017 and the second mixture 1025 is formed into a second shape 1027. In Figure 10C the first shape 1017 is coalesced into a first porous composite block portion 1010 and the second shape 1027 is coalesced into a second porous composite block portion 1020. In Figure 10D the first portion 1010 and the second portion 1020 are placed adjacent one another. Thus a porous composite block 1000 contains a first portion 1010 produced from the first shape 1017 and a second portion 1020 produced from the second shape 1027.

Although the exemplary embodiment of Figures 10A, 10B, 10C, and 10D shows a very simple rectangular block arrangement, any geometry that causes fluids to pass through the first portion 1010 after exiting the second portion 1020 is possible within the embodiments of the invention, as has been discussed above. There can also be a gap or intervening layer(s) between first portion 1010 and second portion 1020 in the block 1000.

In some embodiments, arranging the first mixture into a first shape and arranging the second mixture into a second shape adjacent the first shape involves using a mold. In some arrangements, a removable barrier lamina is placed into a mold. The first mixture is introduced into the mold on one side of the lamina and the second mixture is introduced into the mold on the opposite side of the lamina. Then the lamina is removed from the mold. In other embodiments, arranging a mixture into a shape involves extruding the mixture through a die.

Coalescing the shapes into a porous composite block can be done in a variety of ways. In some arrangements, the shapes are coalesced simply by allowing the mixtures to set. In other arrangements, energy is supplied to coalesce the shapes. Useful energies include electromagnetic radiation, radiative heating, inductive heating, electrically resistive heating, exothermic reactions, electric fields, magnetic fields, ultrasound, and light. When heating is desired, temperatures between about 50ºC and 300ºC can be used. In other arrangements, temperatures between about 150ºC and 250ºC can be used.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

What is Claimed is:

1. A fluid treatment system, comprising: a) a fluid source; b) a porous composite block configured to receive the fluid from the fluid source and to provide treatment to the fluid, the porous composite block comprising: a first portion containing a binder and first active particles of a predominant first active particle type, the first active particles having a first particle size; and a second portion upstream of the first portion and in fluid communication with the first portion, the second portion containing a binder and second active particles of a second active particle type, the second active particles having a second particle size that is less than about 50 μm; wherein the second particle size is smaller than the first particle size; and c) an outlet portion associated with the porous composite block, the outlet portion providing a way for treated fluid to leave the porous composite block after passing through at least the second portion and the first portion of the porous composite block.

2. A porous composite block for fluid treatment, comprising: a first portion containing a binder and first active particles of a predominant first active particle type, the first active particles having a first particle size; and a second portion upstream of the first portion and in fluid communication with the first portion, the second portion containing a binder and second active particles of a second active particle type, the second active particles having a second particle size that is less than about 50 μm;wherein the second particle size is smaller than the first particle size.

3. The block of Claim 2 wherein the second particle size is less than about 25 μm.

4. The block of Claim 2 wherein the second particle size is less than about 10 μm.

5. The block of Claim 2 wherein the second particle size is less than about 1 μm.

6. The block of Claim 2 wherein the second particle size is less than about 100 nm.

7. The block of Claim 2 wherein the first portion and the second portion are both annular cylinders.

8. A porous composite block for gravity-flow fluid treatment, comprising: a first portion containing a binder and first active particles of a first active particle type; and a second portion and upstream of the first portion and in fluid communication with the first portion, the second portion containing a binder and second active particles of a second active particle type; wherein: no more than a negligible amount of second particles can flow out of the porous composite block during fluid treatment; and the porous composite block can transmit fluid at a rate of at least 0.19 liters/min using gravity alone.

9. A method of treating a fluid, comprising: providing a first portion of a porous composite block, the first portion containing a binder and first active particles of a predominant first active particle type, the first active particles having a first particle size, the first portion having a first upstream surface and a first downstream surface; providing a second portion of a porous composite block, the second portion containing a binder and second active particles of a second active particle type, the second active particles having a second particle size, the second particle size being smaller than the first particle size, the second portion having a second upstream surface and a second downstream surface, the second downstream surface adjacent the first upstream surface; introducing a fluid into the second upstream surface; and flowing the fluid through the second portion, into the first portion, through the first portion, and out through the first downstream surface.

10. A method of making a porous composite block for fluid treatment, comprising the steps of: a) providing a first mixture comprising a binder and first active particles of a predominant first active particle type, the first active particle type having a first particle size; b) providing a second mixture comprising a binder and second active particles of a second active particle type , the second active particles having a second particle size, the second particle size being smaller than the first particle size; c) arranging the first mixture into a first shape; d) arranging the second mixture into a second shape adjacent the first shape; and e) coalescing the shapes into a porous composite block having a first portion corresponding to the first shape and a second portion corresponding to the second shape.

11. The method of Claim 10 wherein steps c and d comprise: i) placing a removable barrier lamina into a mold; ii) introducing the first mixture into the mold on one side of the lamina; iii) introducing the second mixture into the mold on an opposite side of the lamina; and iv) removing the lamina.

12. The method of Claim 10 wherein steps c and d comprise extruding the first mixture and the second mixture through dies.

13. The method of Claim 10 wherein coalescing the shapes comprises allowing the first mixture and the second mixture to set.

14. The method of Claim 10 wherein coalescing the shapes comprises supplying energy.

15. The method of Claim 14 wherein supplying energy comprises supplying a form of energy selected from the group consisting of electromagnetic radiation, radiative heating, inductive heating, electrically resistive heating, exothermic reactions, electric field, magnetic field, ultrasound, and light.

16. The method of Claim 14 wherein supplying energy comprises heating to a temperature between about 50 (C and 300 (C.

17. The method of Claim 16 wherein supplying energy comprises heating to a temperature between about 150 (C and 250 (C.

18. A method of making a porous composite block for fluid treatment, comprising the steps of: a) providing a first mixture comprising a binder and first active particles of a predominant first active particle type, the first active particles having a first particle size; b) forming the first mixture into a first shape; c) coalescing the first shape into a first portion of the porous composite block; d) placing the first portion in a mold; e) adding a second mixture comprising a binder and second active particles of a second active particle type to the mold adjacent the first portion, the second active particles having a second particle size, the second particle size being smaller than the first particle size; and f) coalescing the first portion and the second mixture into a porous composite block having a second portion corresponding to the second mixture.

19. A method of making a porous composite block for fluid treatment, comprising the steps of: a) providing a first mixture comprising a binder and first active particles of a predominant first active particle type, the first active particles having a first particle size; b) forming the first mixture into a first shape; c) coalescing the first shape into a first portion of the porous composite block; d) providing a second mixture comprising a binder and second active particles of a second active particle type, the second active particles having a second particle size, the second particle size smaller than the first particle size; e) forming the second mixture into a second shape; f) coalescing the second shape into a second portion of the porous composite block; and g) placing the first portion adjacent the second portion.
